(19) United States
(12) Patent Application Publication
(10) Pub. No.: US 2017/0192091 A1
(43) Pub. Date: Jul. 6, 2017

(54) SYSTEM AND METHOD FOR AUGMENTED REALITY REDUCED VISIBILITY NAVIGATION

(71) Applicant: Ford Global Technologies, LLC, Dearborn, MI (US)

(72) Inventor: Rodrigo Felix, Atizapan de Zaragoza (MX)

(21) Appl. No.: 14/989,450

(22) Filed: Jan. 6, 2016

(51) Int. Cl. G01S 13/93; G01S 13/42; G01S 13/58; G06T 19/00

(52) U.S. Cl. CPC G01S 13/931; G06T 19/006; G01S 13/42; G01S 13/582; G01S 2013/9357

(57) ABSTRACT

Various embodiments of the present disclosure provide an augmented reality reduced visibility navigation system for detecting objects under reduced visibility conditions using a vehicle radar system and an augmented reality display on a windshield or a rearview mirror. More specifically, in one embodiment, a radar-based vehicle control system of a first vehicle detects objects, such as other vehicles, in the vicinity of the first vehicle. The radar-based vehicle control system includes a processor to analyze any detected object, determine the location, distance, and speed of any detected object, and output the object information on an augmented reality display. In one embodiment, the augmented reality display displays a vehicle outline together with the location, direction and speed data. In certain embodiments, the augmented reality display is on the front windshield of the first vehicle. In other embodiments, the augmented reality display is on the rearview mirror of the first vehicle.

### TECHNICAL FIELD

The present disclosure generally relates to a system and method for providing an augmented reality navigation system for use in reduced visibility situations. More particularly, a display system for providing an augmented reality display on the vehicle front windshield and/or rear view mirror for navigation during reduced visibility events.

### BACKGROUND

Inclement weather events such as snow, sandstorms, and heavy fog, may impair viewing conditions for a vehicle driver in spite of having activated fog lams, windshield wipers, etc. In these instances, the vehicle driver can significantly benefit from navigation of surrounding traffic and objects, such as vehicles surrounding the driver's vehicle.

Existing navigation and display systems utilize cameras to detect objects in the road and may display detected objects to the driver, however such systems are also limited under reduced visibility events. That is, cameras may also be obstructed by inclement weather and are similarly susceptible to the limitations caused by reduced visibility events. Even infrared cameras fail under inclement weather conditions because infrared lights bounce off of vegetation. For example, an infrared system in a sandstorm could paint a gray veil, or during a snow storm, such a system would saturate the image white.

Accordingly, there is a need for a solution to these problems. This invention disclosure attempts to overcome the concerns of navigation through reduced visibility events.

### SUMMARY

This application is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detailed description, and such implementations are intended to be within the scope of this application.

Various embodiments of the present disclosure provide an augmented reality reduced visibility navigation system for detecting objects under reduced visibility conditions using a vehicle radar system and an augmented reality display on a windshield or a rearview mirror. More specifically, in one embodiment, a radar-based vehicle control system of a first vehicle detects objects, such as other vehicles, in the vicinity of the first vehicle. The radar-based vehicle control system includes a processor to analyze any detected object, determine the location, distance, and speed of any detected object, and output the object information on an augmented reality display. In one embodiment, the augmented reality display depicts a vehicle outline together with the location, direction and speed data. In certain embodiments, the augmented reality display is on the front windshield of the first vehicle. In other embodiments, the augmented reality display is on the rearview mirror of the first vehicle. Such a configuration is enhances a driver's ability to navigate under reduced visibility circumstances such as sandstorms, heavy fog or snow, etc.

Such a configuration is unique in the fact that it strives to detect threats in front of and in rear of the first vehicle and displays threat information on both the windscreen and rearview mirror in an augmented reality manner. This augmented reality characteristics lies in the fact that the threat is shown in a proportional size and orientation to that of an average saloon car. This will help the driver can quickly identify and assess the threat as if the threat was visible without the reduced visibility condition. Such a configuration provides an extension of the driver's visual capabilities.

### BRIEF DESCRIPTION OF THE DRAWINGS

For a better understanding of the invention, reference may be made to embodiments shown in the following drawings. The components in the drawings are not necessarily to scale and related elements may be omitted so as to emphasize and clearly illustrate the novel features described herein. In addition, system components can be variously arranged, as known in the art. In the figures, like referenced numerals may refer to like parts throughout the different figures unless otherwise specified.

FIG. 1 is a flowchart illustrating a process for operating one example embodiment of the augmented reality reduced visibility navigation system of the present disclosure.

FIG. 2 is block diagram including components of one embodiment of a radar system of the present disclosure.

FIG. 3A is a top view of a first vehicle that is driving on a street behind a second vehicle under reduced visibility circumstances, and the first vehicle including one embodiment of the augmented reality reduced visibility navigation system of the present disclosure.

FIG. 3B is a screen shot of an augmented reality display screen of a navigation system displayed on a front windshield of a vehicle according to one embodiment of the present disclosure.

FIG. 3C is a screen shot of an augmented reality display screen of a navigation system displayed on a rearview mirror of a vehicle according to one embodiment of the present disclosure.

FIG. 4 illustrates a block diagram including components of one embodiment of the augmented reality reduced visibility navigation system of the present disclosure.

### DETAILED DESCRIPTION OF EXAMPLE EMBODIMENTS

While the augmented reality reduced visibility navigation system and method of the present disclosure may be embodied in various forms, there are shown in the drawings, and will hereinafter be described, some exemplary and non-limiting embodiments of the augmented reality reduced visibility navigation system and method. The present disclosure is to be considered an exemplification of the augmented reality reduced visibility navigation system and method and is not intended to limit the augmented reality reduced visibility navigation system and method to the specific embodiments illustrated and described herein. Not all of the depicted components described in this disclosure may be required, however, and some embodiments may include additional, different, or fewer components from those expressly described herein. Variations in the arrangement and type of the components may be made without departing from the spirit or scope of the claims set forth herein.

Various embodiments of the present disclosure provide a system and method for detecting objects under reduced visibility conditions using a vehicle radar system and displaying any detected objects on an augmented reality windshield display or a rearview mirror display. Generally, augmented reality reduced visibility navigation system of the present disclosure includes a radar-based vehicle control system to detect object information of an external vicinity generally forward and rear of a vehicle and to output the detected information to an augmented reality display on a front windshield or a rearview mirror. The radar-based vehicle control system includes a processor configured to analyze the detected object information, determine a location, distance and speed of the detected object, and display the determined information on an augmented reality display on the vehicle windshield or vehicle rearview mirror.

The components of the augmented reality reduced visibility navigation system of the present disclosure (described in detail below) may be included on, within, or otherwise integrated with a vehicle. One or more of the components of the augmented reality reduced visibility navigation system may be shared with one or more components of existing vehicle systems, such as (but not limited to) the navigation system.

The augmented reality reduced visibility navigation system may be included in or otherwise usable with any suitable vehicle, such as (but not limited to): (1) a non-commercial passenger vehicle such as a sedan or a truck; (2) a commercial vehicle such as a tractor-trailer; or (3) a non-civilian vehicle such as a vehicle used by a law enforcement agency, a government agency, an emergency response agency (e.g., a fire response agency), or a medical response agency (e.g., a hospital). This list is not exhaustive, and is provided for exemplary purposes only.

The features, processes, and methods described herein with respect to the capabilities of the augmented reality reduced visibility navigation system may be implemented by a augmented reality reduced visibility navigation tool running on the augmented reality reduced visibility navigation system. The augmented reality reduced visibility navigation tool may be a program, application, and/or combination of software and hardware that is incorporated on one or more of the components that comprise the augmented reality reduced visibility navigation system. The augmented reality reduced visibility navigation tool and the augmented reality reduced visibility navigation system are described in more detail below (and collectively referred to as the augmented reality reduced visibility navigation system for brevity).

Although the vehicle and the features corresponding to the augmented reality reduced visibility navigation system described herein are described below in situations in which the vehicle is moving, it is also within the scope of this disclosure that the same features may apply when the vehicle is in a stationary state (e.g., parked, stopped at a red light, or stopped in traffic).

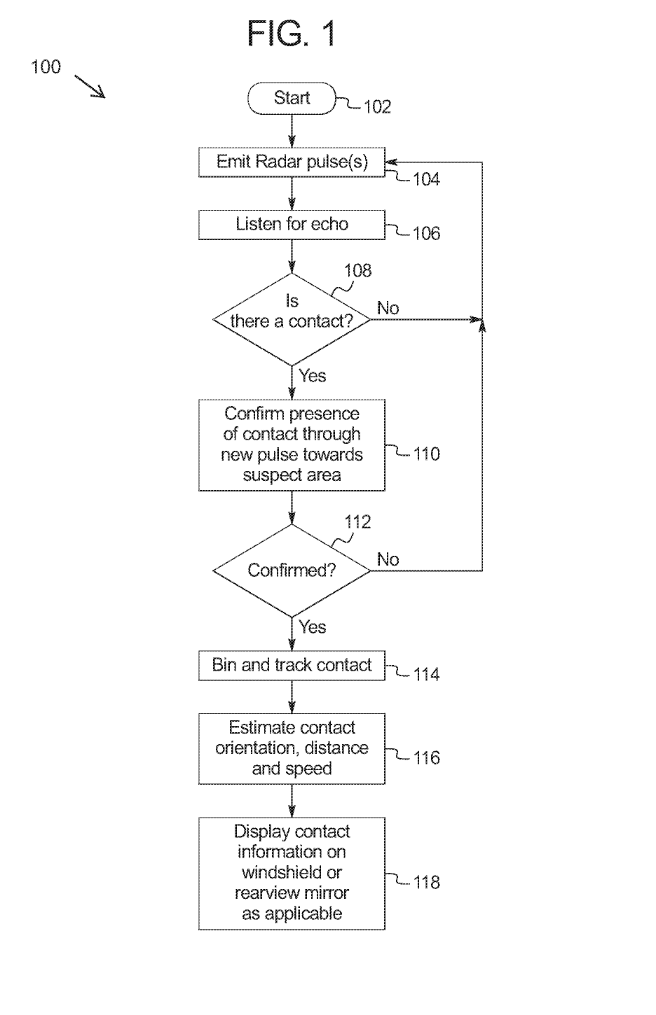

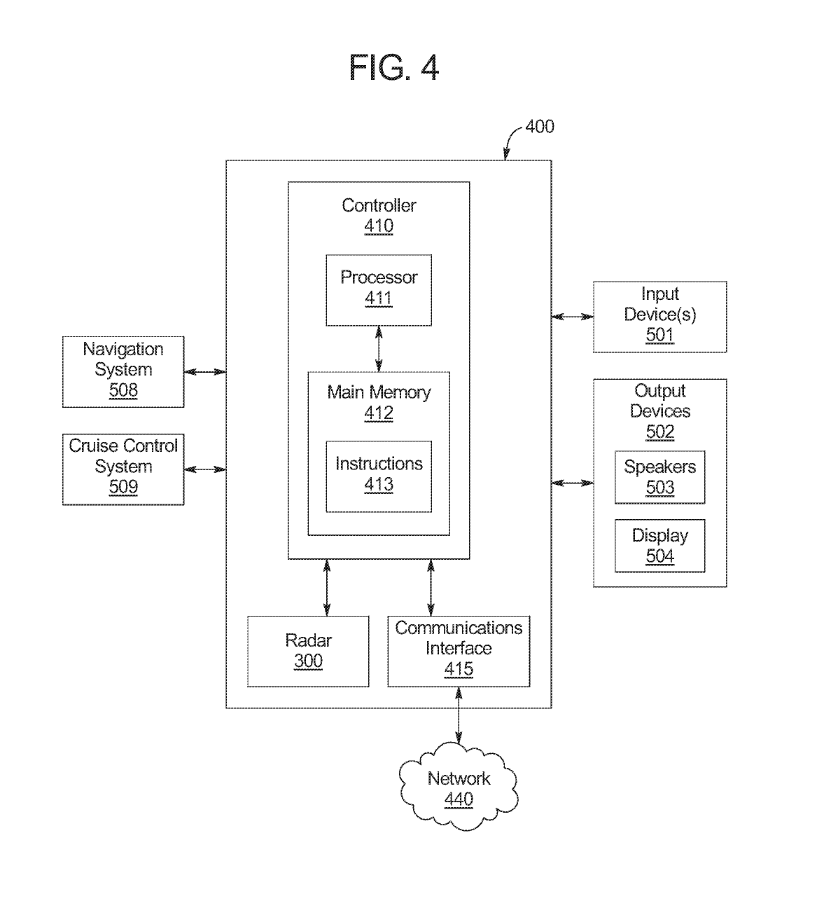

FIG. 1 is a flowchart of an example process or method 100 of operating the augmented reality reduced visibility navigation system of the present disclosure. In various embodiments, the process 100 is represented by a set of instructions stored in one or more memories and executed by one or more processors (such as those described below in connection with FIG. 4). Although the process 100 is described with reference to the flowchart shown in FIG. 1, many other processes of performing the acts associated with this illustrated process 100 may be employed. For example, the order of certain of the illustrated blocks and/or diamonds may be changed, certain of the illustrated blocks and/or diamonds may be optional, and/or certain of the illustrated blocks and/or diamonds may not be employed.

In operation of this embodiment, the example process 100 of operating the augmented reality reduced visibility navigation system initiates at block 102. In one embodiment, the augmented reality reduced visibility navigation system includes a radar-based vehicle control system.

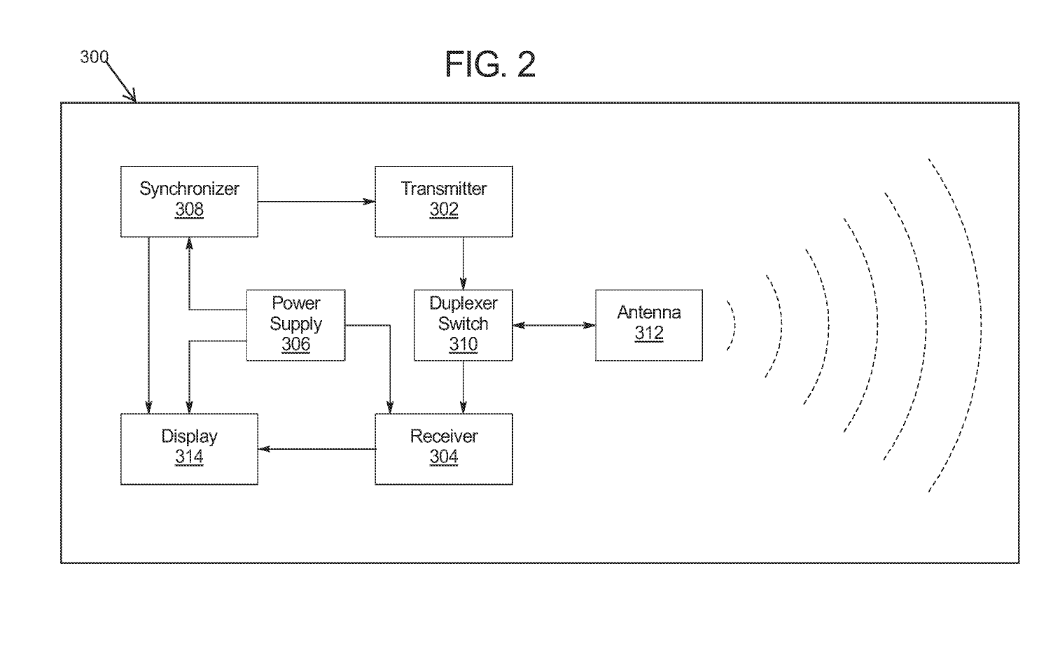

FIG. 2 shows a block diagram of on embodiment of a radar system 300 included in the radar-based vehicle control system. In this embodiment, the radar system 300 includes a radio transmitter 302 to generate radio waves, and an antenna 312 for emitting the radio waves from the vehicle. The radio waves are emitted in pulses. In this embodiment, a synchronizer 308 regulates that rate at which pulses are sent (i.e. sets PRF) and resets the timing clock for range determination at the end of each pulse. When an object, such as another vehicle, is in the space where radio waves are emitted, the object scatters a portion of the radio energy back to the antenna 312. The received radio energy is referred to as an echo. The receiver 304 detects these echoes in the received signal.

In this embodiment, a single antenna 312 is used for both transmission and reception. When a single antenna 312 is used for both transmission and reception, a duplexer 310 is used to switch the radar system 300 from transmit mode to receive mode. It protects the receiver from the high power output of the transmitter 302. A duplexer 310 is not required in low power radar systems. The power supply 306 provides the electrical power for all of the components. In an alternative embodiment, multiple antennas may be used. More specifically, in one embodiment, the vehicle includes three antennas. A first antenna at the front of the vehicle, and the second and third antennas on either side of the rear bumper.

It should also be appreciated that FIG. 2 is a generic block diagram of a radar system. In various embodiments, the radar system includes additional and alternative components that are not shown in this figure. For example, in one embodiment, the radar system includes various amplifiers (not shown) to amplify the radar impulses. More specifically, in example one embodiment, the radar system includes an amplifier (not shown) between the transmitter 302 and the duplexer switch 310 to amplify the radar impulses generated by the transmitter 302. In another embodiment, the radar system includes an amplifier (not shown) between the duplexer switch 310 and the receiver 304. In certain embodiments, the received radar impulses are filtered after they are received. As such, in certain embodiments, there is a filter (not shown) at the output of the receiver 304.

It should further be appreciated that various embodiments also include an analog to digital converter (not shown) to translate the radar signal for the computer. For example, in one embodiment, an analog to digital converter between the receiver 304 and the display 314 is used to convert the received radar impulses from an analog signal to a digital signal before they are analyzed and displayed.

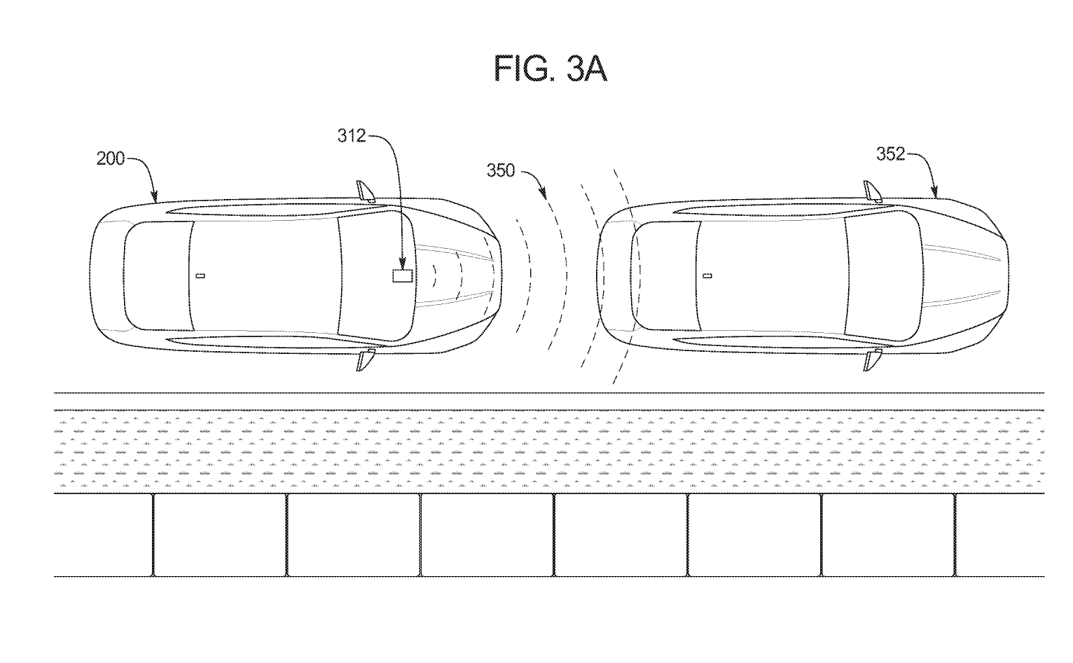

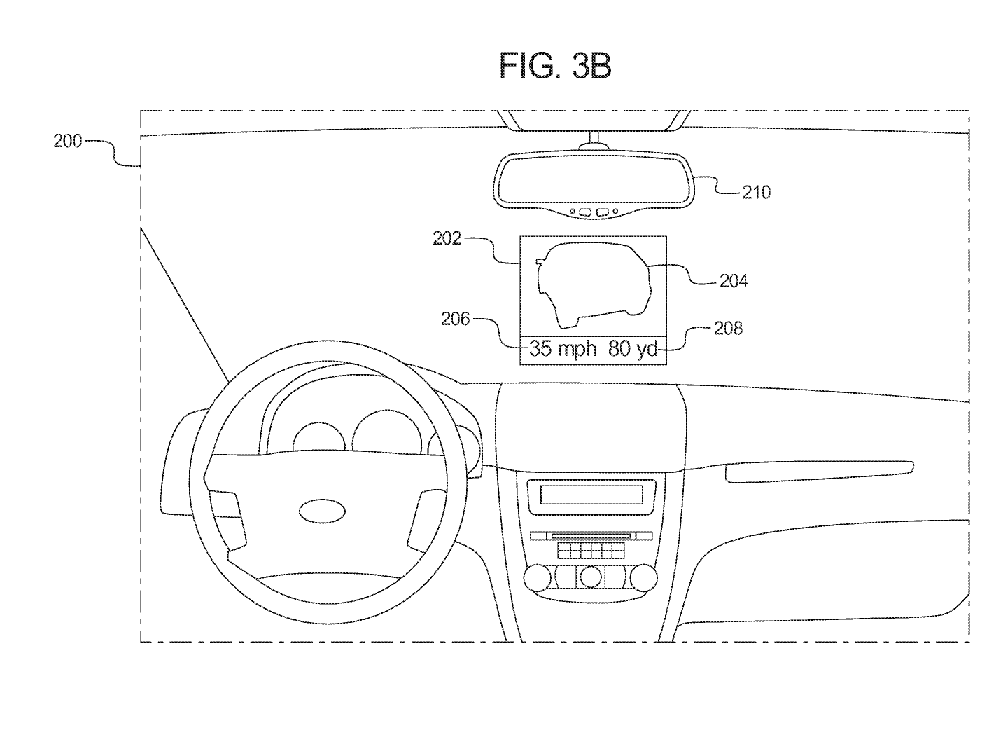

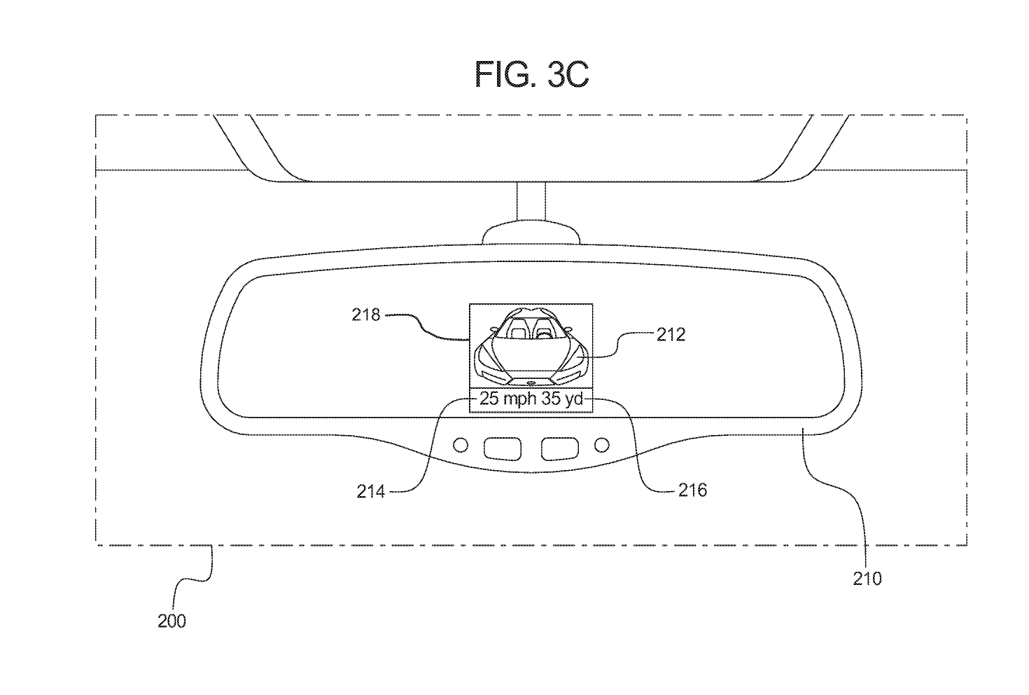

FIG. 3A is a top plan view of a first vehicle 200, which includes one embodiment of the augmented reality reduced navigation system of the present disclosure. In this example embodiment, as the first vehicle 200 drives along a street under reduced visibility circumstances (e.g., heavy fog), and a second vehicle 352 is in front of the first vehicle 200. Under reduced visibility conditions, the driver of the first vehicle may be unable to see the second vehicle 352.

Returning to the example process 100 of FIG. 1, once initiated, the radar-based vehicle control system emits radar pulses to detect objects in the vicinity surrounding a first vehicle, as indicated by block 104. Thus, as shown in FIG. 3A, the radar-based vehicle control system of the first vehicle emits radar pulses 350 from the vehicle antenna 312.

It should be appreciated, that in the depicted example, the radar-based vehicle control system of the first vehicle only emits radar pulses 350 in the forward-looking direction from the antenna 312 of the first vehicle. In certain alternative embodiments, the radar-based vehicle control system of the first vehicle emits radar pulses in all directions surrounding the first vehicle. In other embodiments, the radar pulses are emitted only directly in front of, and behind the first vehicle.

After emitting radar pulses, the radar-based vehicle control system listens for an echo, as indicated by block 106. More specifically, as described above, if the radio waves encounter an object, the radio waves reflect from the object in their path and return an echo. By listening for an echo to return from an emitted radar pulse, the radar-based vehicle control system determines whether there is contact with an object, as indicated by diamond 108. For example, referring back to FIG. 3A, once the radar pulses 350 of the first vehicle contact the second vehicle 352, an echo returns to the first vehicle. If the radar-based vehicle control system receives the echo, the radar-based vehicle control system determines that contact has been made.

If the radar-based vehicle control system determines that there was no contact of any radar pulse to an object near the vehicle, then the radar-based vehicle control system returns to block 104 and emits another radar pulse. That is, the radar-based vehicle control system continues to emit radar pulses, even when no object is detected. This is so that the radar-based vehicle control system continues to monitor the front and rear of the vehicle.

If on the other hand, the radar-based vehicle control system determines that there is a contact, then the radar-based vehicle control system confirms presence of contact through new pulse towards suspect areas, as indicated by block 110. That is, the control system sends additional radar pulses in the direction where the echo returned from to confirm the presence of a contact. As shown in FIG. 1, if the radar-based vehicle control system is unable to confirm presence of an object, the control system returns to block 104 to emit another radar pulse.

If, on the other hand, the radar-based vehicle control system confirms the presence of an object, as indicated by diamond 112, the control system bins and tracks the contact, as indicated by block 114. More specifically, each echo that returns from an emitted radio wave that makes contact with an object provides the radar-based vehicle control system with information regarding the location of the detected object. When searching for objects surrounding the first vehicle, the radar-based vehicle control system may be tracking multiple objects. To manage all echoes received, and contacts made, a processor within the radar-based vehicle control system stores the information related to each contact in an array or matrix within a memory. This process is referring to as “binning.” All of the information collectively forms a matrix within the memory that sorts information regarding each detected object. This memory matrix, or array is updated every radar sweep to track, or keep a record of, the object's contact history. The processor is then able to use this information to track the object's path if the object is moving.

Referring back to FIG. 3A, in this example embodiment, after the first radar pulse returns a first echo indicating that contact was made with the second vehicle 352, the radar-based vehicle control system confirms the presence of the second vehicle 352 through new radar pulses emitted in the direction of the second vehicle 352. After confirming the presence of the second vehicle 352, the radar-based vehicle control system bins and tracks the second vehicle 352. In this embodiment, this data includes a location and distance from the first vehicle 200 that the radio wave made contact.

Returning to FIG. 1, after the radar-based vehicle control system bins and tracks the contact with an object, a processor within the radar-based vehicle control system estimates the contact orientation, distance and speed of the contact object, as indicated by block 116. More specifically, a processor of the radar-based vehicle control system analyzes the echoes returning from each radar pulse and the information gathered in the memory to determine the distance away from the first vehicle the detected object is, the orientation or direction of travel of the detected object, and the speed that the detected object is traveling.

Continuing with the example embodiment described above, to determine the distance between the second vehicle 352 and the first vehicle 200, the processor of the radar-based vehicle control system determines the time taken for a radio wave to travel from the transmitter of the first vehicle 200 to the detected second vehicle and back. Once the processor has determined the location of the second vehicle 352, the processor determines the speed that the second vehicle 352 is traveling and the direction of travel.

After estimating contact orientation, distance, and speed, the radar-based vehicle control system displays contact information on windshield or rearview mirror as applicable, as indicated by block 118 of FIG. 1. More specifically, the information is displayed on an augmented reality display.

Augmented reality display system is a live view of a physical real-world object or environment that is manipulated by computer-generated sensory input such as sound, video, graphics or GPS data. In one embodiment of the present disclosure, and augmented reality display is utilized to display a real-world object outside of the vehicle under reduced visibility conditions. In this embodiment, the augmented reality display depicts an outline of an object, such as a vehicle, and displays speed and distance information regarding the object. Unlike a virtual reality display, which replaces the real world with a simulated one, augmentation is conventionally in real-time and in the context of the actual detected object. Such a configuration enhances a driver's ability to navigate under reduced visibility conditions by enabling the driver of a first vehicle to be aware of an object in the vicinity of the first vehicle even if the driver cannot actually see the object.

Various embodiments of the present disclosure include an augmented reality display on the front windshield of a first vehicle. Turning to FIG. 3B, which is a screen shot of an augmented reality display on the front windshield of the first vehicle 200 depicted in FIG. 3A. As shown in FIG. 3B, a portion of the windshield 202 is dedicated to the augmented display of the objects located outside of the vehicle. This portion of the windshield 202 includes an outline of a standard vehicle 204 to indicate the object that is detected in front of the vehicle.

It should be appreciated that in certain embodiments, the vehicle outline is positioned on the display to depict a relative position as compared to the first vehicle. In other embodiments, the size of the vehicle outline may also be indicative of the distance of the detected object from the first vehicle. That is, the size of the vehicle outline may be proportional to the distance the detected object is from the first vehicle.

Additionally, in this example embodiment, the augmented reality display depicts the speed 206 of the second vehicle 352 and the distance 208 that the second vehicle is away from the first vehicle 200. The radar-based vehicle control system continues to update the speed 206 and distance 208 as the first vehicle 200 and the second vehicle 352 continue to move.

The portion of the windshield 202 on which the augmented display is shown is a reflective portion of the front windshield. In one embodiment, the windshield 202 includes a section with a special reflective film. In this embodiment, the vehicle includes an on-board projector to project the image onto the portion of the windshield 202 with the special film. This display system is similar to the display systems presently included in vehicles for global positioning system head up displays.

Various embodiments of the present disclosure include an augmented reality display on the rearview mirror of a first vehicle. It should be appreciated that drivers are accustomed to looking at a rearview mirror for information regarding objects behind the vehicle. Thus, it is more beneficial for drivers if information regarding objects behind a vehicle is displayed on a rearview mirror rather than on the rear windshield. FIG. 3C depicts a screen shot of an augmented reality display on a rearview mirror of a vehicle. As shown in FIG. 3C, a portion 218 of the rearview mirror 210 includes an augmented display of any detected object behind the first vehicle. Similarly to the display on the front windshield, the augmented display of the rearview mirror 210 includes a vehicle outline 212, and a display of the speed 214 and the distance 216 that the object is from the first vehicle.

In certain alternative embodiments, the detected information is outputted in a different manner. For example, in certain embodiments, the radar-based vehicle control system outputs an audible warning to a warning light or series of lights and possibly a display screen.

It should be appreciated that in the example embodiment described above, the radar-based vehicle control system automatically initiates emitting radar pulses whenever the vehicle is turned on. In an alternative embodiment, the radar-based vehicle controls system initiates only after receiving driver instructions to do so. For example, a driver may actuate an input to start the system of the present disclosure under inclement weather conditions. In other embodiments, the radar-based vehicle control system is automatically initiates when a processor within the radar-based vehicle control system determines a reduced visibility condition. In other embodiments, when the radar-based vehicle control system determines that a reduced visibility condition has occurred, the radar-based vehicle control system queries the driver—such as via a displayed indication and/or an audio indication (e.g., via a touch-screen or voice command)—as to whether the driver desires the radar-based vehicle control system to display detected objects.

An advantage of utilizing a radar-based vehicle control system as opposed to other augmented reality reduced visibility navigation systems is that a radar system is not obstructed by reduced visibility events. Radar systems provide a radar pulse which bounces off of objects in the road. The Radar system does not bounce off of vegetation on the sides of the road and thus will provide accurate information about objects, such as vehicles, in the road.

### Augmented Reality Reduced Visibility Navigation System Components

FIG. 4 illustrates one example embodiment of the augmented reality reduced visibility navigation system 400. Other embodiments of the augmented reality reduced visibility navigation system 400 may include different, fewer, or additional components than those described below and shown in FIG. 4.

The augmented reality reduced visibility navigation system 400 includes a controller 410 comprised of at least one processor 411 in communication with a main memory 412 that stores a set of instructions 413. The processor 411 is configured to communicate with the main memory 412, access the set of instructions 413, and execute the set of instructions 413 to cause the augmented reality reduced visibility navigation system 400 to perform any of the methods, processes, and features described herein. The augmented reality reduced visibility navigation system 400 also includes a radar system 300 (described above) in communication with the controller 410 and a communications interface 415 in communication with the controller 410.

The processor 411 may be any suitable processing device or set of processing devices such as, but not limited to: a microprocessor, a microcontroller-based platform, a suitable integrated circuit, or one or more application-specific integrated circuits (ASICs) configured to execute the set of instructions 413. The main memory 412 may be any suitable memory device such as, but not limited to: volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.); unalterable memory (e.g., EPROMs); and/or read-only memory.

The augmented reality reduced visibility navigation system 400 includes a communications interface 415. The communications interface 415 is comprised of a wired and/or wireless network interface to enable communication with an external network 440. The external network 440 may be a collection of one or more networks, including standards-based networks (e.g., 2G, 3G, 4G, Universal Mobile Telecommunications System (UMTS), GSM (R) Association, Long Term Evolution (LTE) (TM), or more); WiMAX; Bluetooth; near field communication (NFC); WiFi (including 802.11 a/b/g/n/ac or others); WiGig; Global Positioning System (GPS) networks; and others available at the time of the filing of this application or that may be developed in the future. Further, the external network(s) may be a public network, such as the Internet; a private network, such as an intranet; or combinations thereof, and may utilize a variety of networking protocols now available or later developed including, but not limited to, TCP/IP-based networking protocols.

In some embodiments, the set of instructions 413 stored on the main memory 412 and that are executable to enable the functionality of the augmented reality reduced visibility navigation system 400 may be downloaded from an off-site server via the external network 440. Further, in some embodiments, the augmented reality reduced visibility navigation system 400 may communicate with a central command server via the external network 440.

For example, the augmented reality reduced visibility navigation system 400 may communicate image information obtained by the radar system 300 of augmented reality reduced visibility navigation system 400 to the central command server by controlling the communications interface 415 to transmit the obtained information to the central command server via the external network 440. The augmented reality reduced visibility navigation system 400 may also communicate any generated data to the central command server.

The augmented reality reduced visibility navigation system 400 is configured to communicate with a plurality of vehicle components and vehicle systems (such as via one or more communications buses (not shown)) including: one or more input devices 501, one or more output devices 502, a disk drive 505, a navigation system 508 including a global positioning system (GPS) receiver and configured to interface with a GPS to provide location-based information and directions (as known in the art), and a cruise control system 509 (as known in the art).

The input devices 501 may include any suitable input devices that enable a driver or a passenger of the vehicle to input modifications or updates to information referenced by the augmented reality reduced visibility navigation system 400 as described herein. The input devices 501 may include, for instance, a control knob, an instrument panel, a keyboard, a scanner, a digital camera for image capture and/or visual command recognition, a touch screen, an audio input device (e.g., cabin microphone), buttons, a mouse, or a touchpad.

The output devices may include instrument cluster outputs (e.g., dials, lighting devices), actuators, an augmented reality display 504, other displays (e.g., a liquid crystal display (“LCD”), an organic light emitting diode (“OLED”), a flat panel display, a solid state display, a cathode ray tube (“CRT”), or a heads-up display), and speakers 503.

The disk drive 505 is configured to receive a computer readable medium 506. In certain embodiments, the disk drive 505 receives the computer-readable medium 506 on which one or more sets of instructions 507, such as the software for operating the augmented reality reduced visibility navigation system 400, can be embedded. Further, the instructions 507 may embody one or more of the methods or logic as described herein. In a particular embodiment, the instructions 507 may reside completely, or at least partially, within any one or more of the main memory 412, the computer readable medium 506, and/or within the processor 411 during execution of the instructions by the processor 411.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any tangible medium that is capable of storing, encoding or carrying a set of instructions for execution by a processor or that cause a computer system to perform any one or more of the methods or operations disclosed herein.

Any process descriptions or blocks in the figures, should be understood as representing modules, segments, or portions of code which include one or more executable instructions for implementing specific logical functions or steps in the process, and alternate implementations are included within the scope of the embodiments described herein, in which functions may be executed out of order from that shown or discussed, including substantially concurrently or in reverse order, depending on the functionality involved, as would be understood by those having ordinary skill in the art.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

What is claimed is:

1. A reduced visibility vehicle navigation system comprising:
a radar-based vehicle control system of a first vehicle configured to:
detect a second vehicle in a vicinity of the first vehicle; and
determine the location information of the second vehicle; and
an augmented reality display on a rearview mirror display information about the second vehicle if the second vehicle is behind the first vehicle.

2. The system of claim 1, further comprising an augmented reality display on a front windshield to display information about the second vehicle if the second vehicle is in front of the first vehicle.

3. The system of claim 1, wherein the radar-based vehicle control system is further configured to:
emit radar pulses from an antenna to detect the second vehicle in the general vicinity of the first vehicle; and
receive a return signal from the emitted radar pulse.

4. The system of claim 3, wherein the radar-based vehicle control system is further configured to:
analyze, by a processor, the received return signal to determine the location information of the second vehicle; and
store in a memory the determined location information from the received return signal to track the detected object.

5. The system of claim 1, wherein the determined location information includes a distance between the second vehicle and the first vehicle.

6. The system of claim 1, wherein the determined location information includes a speed that the second vehicle is traveling.

7. The system of claim 1, vehicle navigation system displays a vehicle outline representing the second vehicle on the augmented reality display.

8. The system of claim 1, wherein the augmented reality display is made from a reflective material.

9. A reduced visibility vehicle navigation system comprising:
a radar-based vehicle control system configured to:
detect an object in a vicinity of a vehicle; and
determine the detected object location information; and
an augmented reality display displaying the detected object information including the determined location information.

10. The system of claim 9, wherein the augmented reality display is on a front windshield.

11. The system of claim 9, wherein the augmented reality display is on a rearview mirror.

12. The system of claim 9, wherein the radar-based vehicle control system is further configured to:
emit radar pulses from an antenna to detect an object; and
receive a return signal from the emitted radar pulse.

13. The system of claim 9, wherein the radar-based vehicle control system is further configured to:
analyze, by a processor, the received return signal to determine object information; and
store in a memory the determined object information from the received return signal to track the detected object.

14. The system of claim 9, wherein the determined object location information includes a distance between the detected object and the vehicle.

15. The system of claim 9, wherein the determined object location information includes a speed that the detected object is traveling.

16. A method of operating a reduced visibility vehicle navigation system comprising:
detecting a second vehicle in a general vicinity of a first vehicle by a radar-based vehicle control system of the first vehicle;
determining the location information of the second vehicle; and
if the second vehicle is behind the first vehicle, displaying on an augmented reality display on a rearview mirror, location information of the second vehicle.

17. The method of claim 16, wherein if the second vehicle is in front of the first vehicle, the second vehicle location information is displayed on an augmented reality display on a front windshield of the first vehicle.

18. The method of claim 16, wherein the radar-based vehicle control system is detects the second vehicle by emitting radar pulses from an antenna in the general vicinity of the first vehicle; and receiving a return signal from the emitted radar pulse.

19. The method of claim 16, further comprising the radar-based vehicle control system analyzing, by a processor, the received return signal to determine the location information of the second vehicle; and storing in a memory the determined location information from the received return signal to track the detected object.

20. The method of claim 16, wherein the determined location information includes at least one from the group of: (a) a distance between the second vehicle and the first vehicle; (b) a speed that the second vehicle is traveling; and (c) a vehicle outline representing the second vehicle on the augmented reality display.
